(19) United States
(12) Patent Application Publication
(10) Pub. No.: US 2002/0164560 A1
(43) Pub. Date: Nov. 7, 2002

(54) Acceleration sensitive electric motion platform and a control system for controlling the same

(75) Inventor: Ronald T. Borta, Warrenton, VA (US)

Correspondence Address: FOLEY AND LARDNER, SUITE 500, 3000 K STREET NW, WASHINGTON, DC, 20007, US

(73) Assignee: RONBOTICS CORPORATION

(21) Appl. No.: 10/137,324

(22) Filed: May 3, 2002

Related U.S. Application Data
(60) Provisional application No. 60/288,423, filed on May 4, 2001.

(51) Int. Cl. G09B 9/08; G09B 19/16

(52) U.S. Cl. 434/55

(57) ABSTRACT

A motion platform for supporting a g-force sensitive load, the motion platform includes base, a top having a g-force sensitive load bearing portion and a support portion. A support member supports the top relative to the base with freedom of movement about at least one horizontal axis and a pair of positioning motor assemblies mounted to the base. A respective arm assembly extends between each of the positioning motor assemblies and the top, and a microcontroller is electrically connected to the positioning motor assemblies for controlling a rotational speed and a rotational direction of said positioning motor assemblies and thus angular displacement of said top of the motion platform. The g-force sensitive load bearing portion of the top is displaced from the support portion of the top at which the support member supports the top. The arm assembly is responsive to rotary motion of a respective one of said positioning motor assemblies and adapted to rotate 360 degrees about the respective positioning motor assembly to effect relative movement of the top about the at least one axis.

### CROSS-REFERENCE TO RELATED APPLICATIONS

This application claims the benefit of priority under 35 U.S.C. §119(e) of provisional application serial No. 60/288,423 entitled “Acceleration Sensitive Electric Motion Platform and a Control System for Controlling the Same,” filed on May 4, 2001, the disclosure of which is incorporated herein in its entirety.

### BACKGROUND OF THE INVENTION

This invention relates to a novel acceleration sensitive electric motion platform and method of controlling movement of the same. More specifically, this invention relates to an electric motion platform for simulating real world motion for g-force sensitive loads under direction of a computer or other external device.

Motion platforms may be found in both military and commercial environments, for example in flight simulators, coin-operated entertainment rides, medical research, and, more recently, virtual reality machines. In a typical application, one or two person module, such as a simulated “cockpit” in a flight training system, is mounted to the motion platform. As the user watches screens displayed in the module, the platform moves so that the user experiences true-to-life motion cues. Motion platforms for commercial flight simulation are designed for accuracy and, consequently, are quite expensive.

Conventional motion platforms that attempt to simulate real world motion suffer several drawbacks. The motion platforms are complicated in structure, having many distinct moving parts, and thus are expensive to manufacture and maintain. In addition, the movement of the motion platform is somewhat restricted. Conventional motion platforms undergo what is referred to as quadrature motion, driven by a motor and a pair of arms, one of which is connected to the platform. In these conventional motion platforms, as exemplified in FIG. 2A, arms 201 and 203 are connected to a motor box 205 that rests on a platform base 207. Arm 203 connects to a corner of the platform (not shown), and an identical motor and arm assembly is at an opposite corner of the platform.. As is evident from the figure, the movement of arm 201 in a downward direction is limited by the base, with the result that the maximum angular deflection of the platform is that which results from motion of the arms over a single 90° arc or quadrant in the direction of arrow A. Movement of the motion platform itself thus is usually restricted to about ±15 degrees from a plane parallel to the ground surface.

Another disadvantage of conventional motion platforms is that, because of the 90° orientation of the arms at the start position, the motor is at its highest load when started. Accordingly, these platforms require large, heavy motors, which are both heavy and costly. While weight and cost may not be significant factors for custom designed motion platforms used for military or high-end commercial applications; they have limited the application of such platforms in entertainment and other potential commercial applications.

Conventional motion platforms are also designed that such that a top of the motion platform that supports a user module is designed to be relatively stable and, therefore, the top of the motion platform is supported by a support member approximately near a center of gravity of the top. Furthermore, the user module is also generally arranged approximately over the portion of the top where it is supported by the support member. Therefore, the top portion is arranged in a stable configuration and user modules arranged thereon cannot be easily moved or accelerated to provide simulations of g-force simulation movements for user modules that require such simulations. For example, cockpit simulators, flight training modules, or even video games that attempt to simulate a flying or cockpit environment cannot be realistically simulated on conventional motion platforms that are designed so that user modules are positioned substantially over a central portion of the top of the motion platform.

For these and other reasons, the motion platforms heretofore available have not proven to be entirely satisfactory and have not been fully suitable for practical application to the entertainment industry and to other commercial applications in which cost, size, convenience, and simulation of g-force sensitive motion are important factors.

### SUMMARY OF THE INVENTION

Accordingly, it is therefore a general object of the present invention to provide a motion platform and control system for controlling movement of the same which will obviate or minimize difficulties of the type previously described.

It is a specific object of the invention to provide a general purpose, digitally controlled motion platform and associated control system that has a wide variety of applications.

These and other objectives are achieved by providing a motion platform for supporting a g-force sensitive load, the motion platform including a base; a top having a g-force sensitive load bearing portion and a support portion; a support member for supporting the top relative to the base with freedom of movement about at least one horizontal axis; a pair of positioning motor assemblies mounted to the base; a respective arm assembly extending between each of the positioning motor assemblies and the top; and a microcontroller electrically connected to the positioning motor assemblies for controlling a rotational speed and a rotational direction of the positioning motor assemblies and thus angular displacement of the top of the motion platform, wherein the g-force sensitive load bearing portion of the top is displaced from the support portion of the top at which the support member supports the top.

In one aspect of the present invention, the arm assembly is responsive to rotary motion of a respective one of the positioning motor assemblies and is adapted to rotate 360 degrees about the respective positioning motor assembly to effect relative movement of the top about at least one axis.

In one aspect the present invention, the motion platform includes a first beam extending across the support portion of the top and a second beam extending across the base, wherein the support member includes a support beam extending between, and perpendicular to, the first beam and the second beam.

In one aspect of the present invention, the second beam bisects the base, and the support beam extends along an axis intersecting a center of the base.

In a further aspect of the present invention, the motion platform includes a base that is generally rectangular and a top that is generally rectangular.

In one aspect of the present invention, a length of a side arm of the top of the motion platform is greater than a length of a side arm of the base.

In a further aspect of the present invention, the base and the top of the motion platform are composed of an aluminum alloy.

In one aspect of the present invention, the present invention includes a solid state relay and delay circuitry electrically connected between the positioning motor assemblies and the microcontroller to allow relatively instantaneous reversal of a direction of rotation of the positioning motor assemblies.

In a further aspect of the present invention, the base and top of the motion platform are generally rectangular and have a front arm, a rear arm, and two side arms, the motion platform further includes a first beam connected between the two side arms of the top at the support portion of the top, a second beam bisecting said base, and a fourth beam connected between the two side arms at the g-force sensitive load bearing portion of the top, the support member including a third beam extending between a center of the first beam and a center of the second beam, and motor supports extend from the second beam to a top surface of the rear arm of the generally rectangular base, thereby elevating the positioning motor assemblies relative to the base.

In one aspect of the present invention, each arm assembly includes a rotating arm for connection to an output of a respective one of the positioning motor assemblies, a connecting arm for connecting a side arm of the top to the rotating arm, and a joint for coupling the rotating arm to the connecting arm to allow angular displacement of the connecting arm relative to the rotating arm.

In another aspect of the present invention, when the top of the motion platform is at a start position, the rotating arm and the connecting arm form an obtuse angle.

A further aspect of the present invention provides for a user module mounted to the g-force sensitive load bearing portion of the top of the motion platform.

In yet another aspect, the present invention provides a method for controlling movement of a motion platform supporting a g-force sensitive load, the method including the steps of: providing a motion platform having a base and a top, the top having a g-force sensitive load bearing portion and a support portion wherein the g-force sensitive load bearing portion is displaced from the support portion; initializing the motion platform so that a top of the motion platform is level; receiving data input into a data entry unit, the data being converted into signals for controlling activation, speed, and direction of rotation of positioning motors for positioning the motion platform; activating the positioning motors in response to the received data; when the positioning motors are activated, moving the positioning motors in a specific direction and at a specific speed in response to the received data to orient the motion platform.

In a further aspect of the present invention, the data entry unit receives at least one of real-time data or predetermined data.

Additional objects and advantages of the invention will be apparent to those of ordinary skill in the art from the following description of a preferred embodiment, or may be learned by practice of the invention. The objects and advantages of the invention may be realized and obtained by means of the instrumentalities and combinations particularly pointed out in the appended claims.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a perspective view of a preferred embodiment of a motion platform in accordance with the present invention;

FIG. 2 is a side elevation view of the motion platform of FIG. 1;

FIG. 2A is a side elevation view of a motor and arm assembly of a prior art motion platform;

FIG. 3 is a rear elevation view of the motion platform of FIG. 1;

FIG. 4 is a top plan view of the motion platform of FIG. 1;

FIG. 5 is a block diagram illustrating the microcontroller and electrical system of the motion platform in accordance with the present invention; and

FIGS. 6A through 6E are flow diagrams of exemplary microcontroller programs which controls operation of the motion platform in accordance with the invention.

### DETAILED DESCRIPTION OF THE PREFERRED EMBODIMENTS

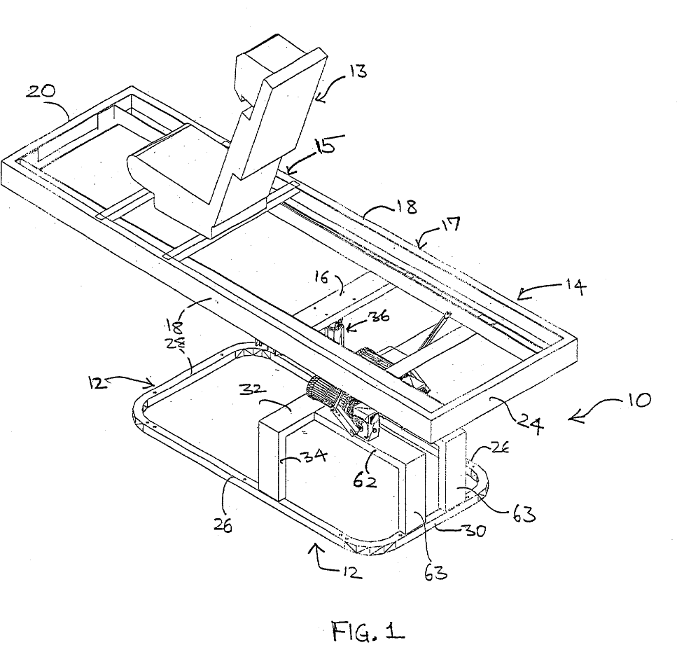

Referring now to the drawings, wherein like numerals indicate like parts, and initially to FIG. 1, there will be seen a motion platform, generally indicated 10, in accordance with the invention. The motion platform 10 includes a base 12 and a top 14 for supporting an exemplary user module 13. The user module 13 may be a flight simulator module, an entertainment ride film module, a game module or any other desired type of module pod or body designed to simulate a real world device or vehicle. In a preferred embodiment, the user module 13 is a flight or cockpit simulator so that that it includes the look and feel (including the instrumentation dials) of an aircraft cockpit.

In the preferred embodiment, the base 12 and the top 14 are generally rectangular. One of skill in the art, however, will readily recognize that either or both of the top and the base may have different cross-sectional shapes, such as circles, rectangles, hexagons and the like.

The top 14 and the base 12 preferably are formed from a single piece of metal, bent into the rectangular configuration shown in FIG. 1. The top 14 and the base 12 are preferably composed of an aluminum alloy, which reduces the overall weight of the motion platform relative to conventional motion platforms made of steel. Standard aluminum alloy, in standard mill sizes, provides an adequate strength-to-weight ratio, well above required safety limits for motion platforms. While weighing significantly less than steel and having excellent working characteristics, the aluminum design lends itself to automated manufacturing techniques required to produce large quantities and low cost. It will be understood, however, that the subject motion platform 10 may also be made of steel or any other material suited to the intended application.

The top 14 has a first beam 16 extending between two side arms 18 of the top 14. The first beam 16 connects to the side arms 18 of the top 14 at a support portion 17 of the top 14. The first beam 16 is mounted to the side arms 18, for example, by mounting brackets.

In addition, the top includes a g-force sensitive load bearing portion 15 which is displaced (off-centered) from the support portion 17 so the user module 13 can be attached to the top 14 at the g-force sensitive load bearing portion 15. In a preferred embodiment, a fourth beam 19 is provided between the two side arms 18 at the g-force sensitive load bearing portion 15 so that the fourth beam 15 can provide the attachment point for a g-force sensitive user module such as the user module 13.

The off-center (or displaced from the support portion 17) position of the user module 13 that is attached to the g-force sensitive load bearing portion 17 (for example, by attachment to the fourth beam 15) provides that greater g-force simulated motion can be provided to the user module 13 by the platform 10. This is because the off-center position of the user module 13 enhances the motion (and acceleration) experienced by the user module 13 positioned at the g-force sensitive load bearing portion 15 of the top 14 of the motion platform 10 compared to a user module that may be positioned substantially over the support portion 17 of the top 18 of the motion platform 10. This enhanced motion and acceleration experienced by the off-center positioned user module according to the present invention provides for generation of g-forces that are especially suitable for a more realistic flight simulation and provides for a more effective rides or other simulations where the generation of higher g-forces is desired. As would be recognized by one skilled in the art, the greater the off-center positioning of the g-force sensitive load bearing portion 15 (and the user module 13 attached thereon), the greater would be the enhanced motion and acceleration experienced by the user module 13 when compared a user module positioned substantially over the support portion 17 of the platform 10. The top 14 of the motion platform 10 is completed by a front arm 20 and a rear arm 24.

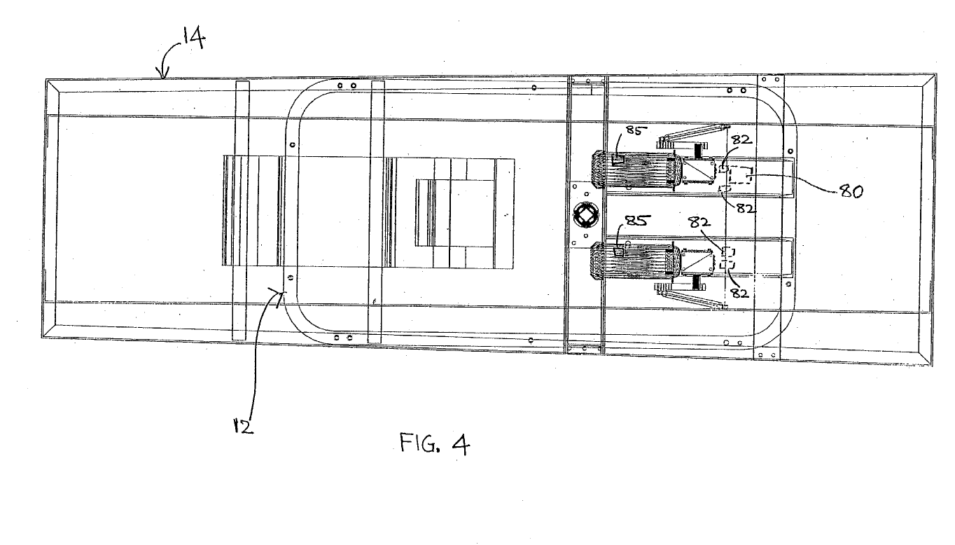

Like the top 14, the base 12 includes side arms 26, a front arm 28, and a rear arm 30. The perimeter of the base 12 bounds an area of generally smaller cross-section than the perimeter of the top 14, as best seen in FIG. 4.

A second beam 32 extends between the two side arms 26 of the base 12. This second beam 32 is elevated from the side arms 26 by, for example, vertical beams 34 that are connected to the side arms 26 of the base 12.

A support member, generally indicated 36, supports the top 14 relative to the base 12. The support member 36 supports all of the weight of the top 14 and any attached user module 13. The support member 36 includes a support beam 38, here shown as a vertical post, that vertically extends between a center of the first beam 16 and a center of the second beam 32. The support beam 38 may be reinforced to provide maximum stiffness and strength to the motion platform and, in combination with a joint 44, discussed below, supports the load of the top 14 and any additional load, such as a user and user module 13.

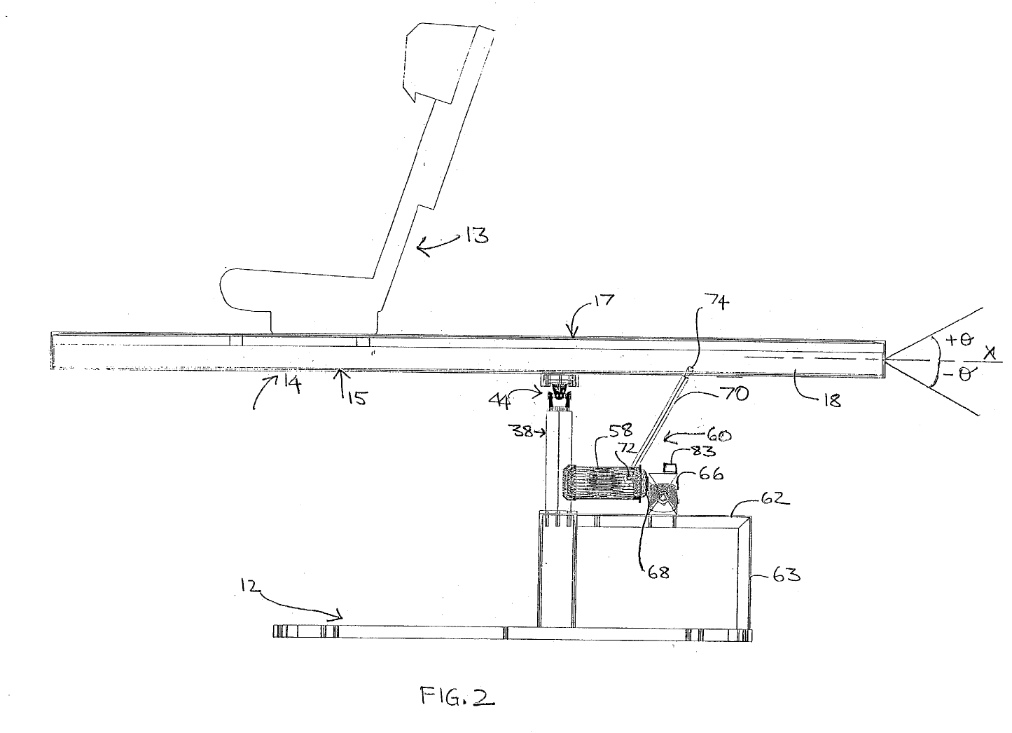

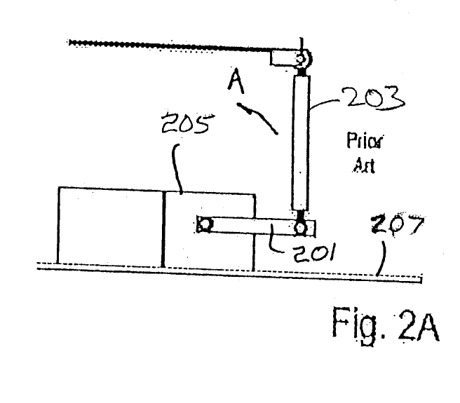

As seen in FIG. 2, a joint, generally indicated 44, is positioned between the support beam 38 and the first beam 16. The joint 44, which is preferably a heavy industrial universal joint or U-joint, allows a desired degree of pitch and roll of the top of up to ±35 degrees relative to the base. The joint 44 has a first fixed member 46 mounted to a top 48 of the support beam 32. The joint 44 provides pivot points that enable the top 14 to move in two degrees of freedom pivot relative to the support beam 38.

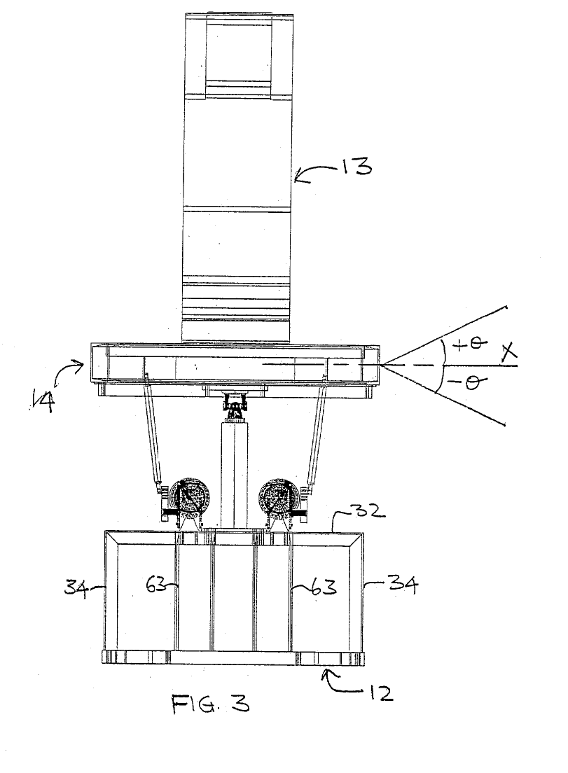

The motion platform 10 also includes a pair of positioning motors 58 that rotate a pair of arm assemblies, generally indicated as 60, to enable up to a ±35 degree range of motion of the top 14 relative to a horizontal plane shown as plane X in FIGS. 2 and 3. The pitch, or up down, movement of the motion platform 10 is shown as ±Θ in FIG. 2. When the platform moves at a +Θ angle, the front arm 20 of the top 14 moves down. When the platform moves at a −Θ angle, the front arm 20 moves up. The angle Θ is also shown in FIG. 3 to show the range or extent of roll of the top 14 of the platform 10.

The positioning motors 58 are mounted on motor support beams 62, which in turn extend between the second beam 32 and the rear arm 30 of the base 12. The motor support beams 62 elevate the positioning motors 58 above the plane of the base 12, for example, by being attached to vertical beams 63 that are attached to the rear arms 30 of the base 12 of the motion platform 10 according to the present invention. One skilled in the art would recognize that the top 14 of the motion platform 10 has to be sufficiently raised (for example by appropriately designing the height of the vertical beams 34) so that the front arm 20 of the top 14 clears the ground when the front arm 20 is moved to its lowest position.

One of the important features of the off-center motion platform of the present invention requires the use of suitable positioning motors and arm assemblies that can provide sufficient power and movement to the off-centered user module that is displaced from the support portion 17 of the top of the motion platform 10. Accordingly, the present invention provides that the positioning motors 58 are high torque motors. They provide the rotary motion to rotate the arm assemblies 60. To achieve accurate positioning of the top 14 through rotation of the arm assemblies 60, the motors can be instantly reversed to provide braking or to provide reverse motion, as required and as will be more fully described below.

The motion platform 10 further includes a reducer gear 66 coupled between each positioning motor 58 and its respective arm assembly 60. Like the positioning motors 58, the reducer gears 66 are mounted to the motor support beams 62. The reducer gears 66 have worm gear arrangements that reduce the speed of the positioning motors 58 to a desired rate. At the same time, because of the friction angle of the gearing, the reducer gears 66 provide braking to the arm assemblies 60 to prevent the top 14 from moving under changing loads at undesirable times.

Each arm assembly 60 includes a rotating arm 68 rotatably connected at one end to the output shaft of reducer gear 66 and thus to the positioning motor 58. The other end of the rotating arm 68 is rotatably connected to one end of a connecting arm 70 by a rotating ball joint, or rod end, 72. The other end of the connecting arm 70 is connected to a lower surface of the respective side arm 18 of the top 14 by another rotating ball joint, or rod end, 74. The joints 72 and 74 operate so that the connecting arm 70 and the rotating arm 68 provide a rotating, variable angle joint to effect displacement of the top 14 and result in various combinations of pitch and roll during use of the motion platform 10. The dimensions of the arms 68 and 70 and the elevation of the positioning motor 58 and reducer gear 66 above ground level may be adjusted to control the maximum available pitch and roll angle.

The rotating arm 68 is rotatably connected to the output shaft of reducer gear 66 so as to be rotatable about the shaft axis a full 360 degrees. The ability of the rotating arm to rotate 360 degrees provides a wider range of motion, pitch and roll, for the motion platform than possible in conventional motion platforms restricted to quadrature motion, as seen in FIG. 2A. In addition, the ability to rotate 360 degrees means that, in a single complete rotation of the motor, the platform “reverses” direction (goes from up-down to down-up), yet the motor need not reverse direction. Reversing the direction of the motor requires more work by the motor. The dimensions of the rotating arm 68 and the connecting arm 70 and the elevation of the positioning motor 58 above the base 12, in combination, enable this 360-degree rotation.

When the top 14 is in a level start position, as shown in FIG. 2, the rotating arm 68 and the connecting arm 70 form an obtuse angle φ. A benefit of a start position where the arms 68 and 70 form a non-right angle is that the positioning motors 58 are required to use less power to initiate rotational movement than those operating under quadrature motion (see FIG. 2A). As a result, the motion platform 10 of the present invention may be run with smaller, and hence, more compact, lighter and inexpensive motors 58. In conventional motion platforms, the linkage between the motor and the platform top is at a 90-degree angle at the start position (see FIG. 2A), and thus motor must initiate movement when it is at its highest load.

The connecting arm 70 enables static alignment of the motion platform 10. The connecting arm 70, preferably, is hollow and has threaded ends, which connect respectively to the rotating ball joints or rod ends 72 and 74. Thus, the length of connecting arm 70 may be readily adjusted by threading either or both of the joints 72 and 74 into or out of the arm until the top 14 is in the desired position relative to base 12. In this manner, the connecting arm 70 may be used to align/level the motion platform 10.

The positioning motors 58 operate independently. In this way, the positioning motors 58 cause rotation of their respective rotating arms 68 to achieve whatever desired pitch, roll motion or vibration effects are desired. The motion platform 10 is thus capable of simulating real world movements by producing movement cues replicating or simulating those experienced in real world situations.

A control system for the motion platform 10 will now be described in conjunction with FIGS. 4-6. A microcontroller 80 is mounted to a lower surface of one of the motor support beams 62. The microcontroller 80 controls all functionality of the motion platform 10. Also mounted to the lower surface of the motion support beams 62 are four solid state relay and delay circuits 82, which will be referred to as relays 82, mounted two on each beam 62. These pairs of relays 82 are electrically connected to the microcontroller 80 and to each of the respective positioning motors 58. The relays 82 allow relatively instantaneous reversal of direction and control of rotation of the positioning motors 58.

The motion platform 10 further includes sensors. The sensors preferably are infrared emitting LEDs and photo-transistors. First sensors 83 are mounted to a top surface of each of the reducer gears 66 to sense a position of a respective rotating arm 68. The first sensors 83 detect when the position of the respective rotating arms 68 are in the home position, as shown in FIG. 2. Light is reflected onto the respective sensor 83 from the rotating arm 68 as the rotating arm enters the home position. Second sensors 85 are mounted to the positioning motors 58. The positioning motors 58 may comprise A/C motors or DC motors, both of which have cooling fans with equally spaced blades. Each of the second sensors 85 senses the passage of an edge of each fan blades as that edge passes in front of the sensor 85.

The microcontroller 80 is responsive to digital input commands and to feedback signals generated by both sets of sensors 83 and 85. The microcontroller controls the start/stop, rotational direction, rotational speed and vibration of the positioning motors 58 in response to the input command signals supplied to the microcontroller 80 and the position, speed and extent of movement information provided by the sensors 83 and 85, as will be fully described below.

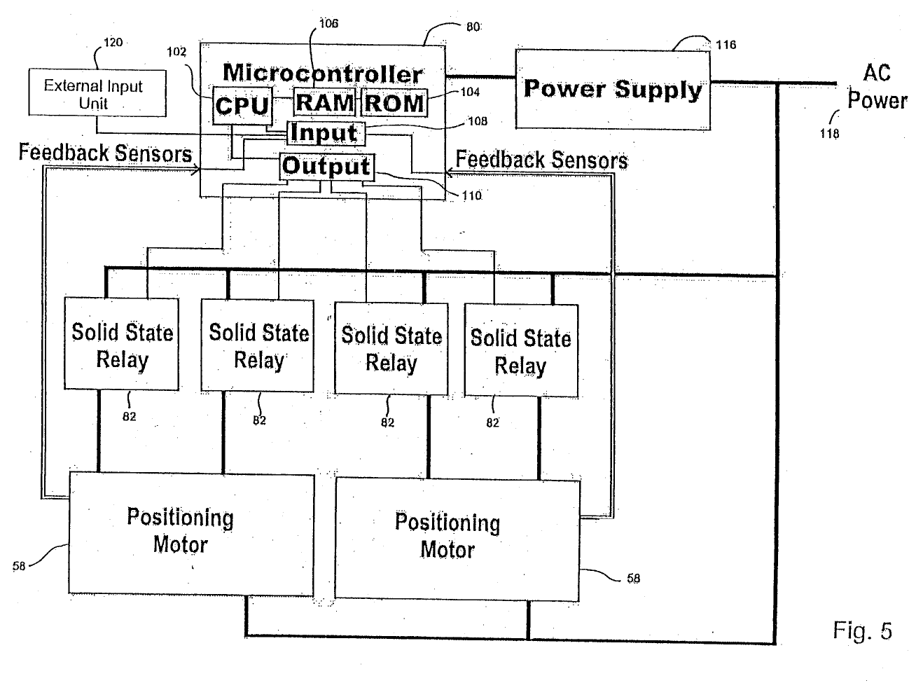

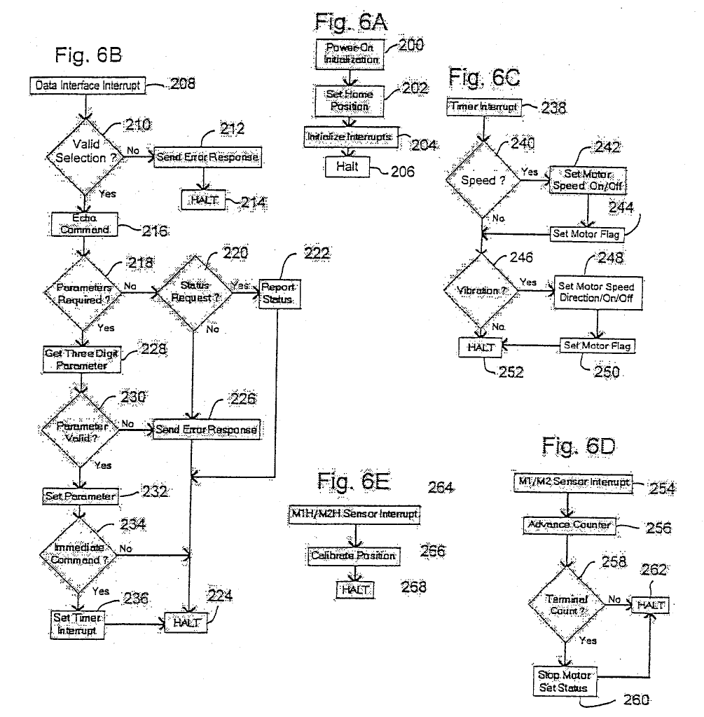

FIG. 5 is a block diagram of the electrical control system of the motion platform 10 of the present invention. The microcontroller 80 includes a central processing unit (CPU) 102, storage in the form of ROM 104 and RAM 106, an input interface 108, and an output interface 110. The CPU 102 is preferably an 8-bit microcomputer optimized for real-time control applications. RAM 106 serves as temporary storage, and ROM 108 stores programming associated with operation of the motion platform 10, such as the programming associated with the flowchart shown in FIG. 6. The input interface 108 receives signals from sensors 82 that sense the position of the rotating arm 68 and the passage of the fan blades of the positioning motors 58, as described above. The input interface 108 transmits these sensor signals to the CPU 102 for processing. The CPU 102 sends processed signals to the output interface 110, which outputs signals to the solid state relays to drive the positioning motors 58, as desired. The microcontroller 80, through its output lines, controls the ON/OFF state and speed and direction of rotation of the positioning motors 58 based on sensor signals input into the microcontroller 80.

The relays 82 switch the positioning motors 58 ON and OFF at a rapid rate which is fast enough to control both the speed and the degree of rotation of the positioning motors 114. If it is desired to operate the motors 58 at full speed, for example, the relays 82 are turned on and kept on without interruption. If a reduced speed is desired, the relays 82 are switched on and off to supply the motors with an interrupted or pulsed input voltage. The lower the frequency of the pulse train, the slower the speed of the motor and vice-versa. In this way, by controlling the cycle of the relays 82, the motor speed is directly regulated. Similarly, by controlling the polarity of the motor input signal through the relays, the direction of rotation may be controlled. Finally, by combining control of the direction and speed signals fed to the relays 82, the motors can be caused to move in a stepwise or interrupted manner at any desired rate or degree, thereby imparting any number of desired vibration effects to the top 14 of the platform 10.

The motion platform 10 also includes a power supply 116 adapted to be connected to a suitable A/C power source 118 to provide power to the microcontroller 80.

The motion platform 10 is adapted to receive command signals from an external command signal input unit 120, such as a computer terminal or other device capable of transmitting and receiving computer readable characters, that electrically communicates with the CPU 102 through the interface input unit 108. Data parameters and operational commands may be supplied by the input source 120 in accordance with any desired sequence to produce a pattern or programmed sequence of movement of the top 14 of platform 10 relative to base 12. Such data and operational commands include (in a preferred embodiment): home-straight and level (H), pitch angle positive (P), pitch angle negative (N), acceleration (A, roll angle right (R), roll angle left (L), set speed (SP and SR) for each motor, set vibration (VP and VR) for each motor, status (Q), and ON/OFF (T).

The motion platform 10 receives all its commands from the external input unit 120. Where the motion platform 10 is used as part of an arcade-type game system, for example, the external input unit 120 may consist of a joystick or controller operated by a player (or “rider”) to produce signals recognizable by the microcontroller's CPU 102. If the motion platform 10 is used as part of a programmed ride, the external input unit 120 may consist of a programmed computer or date storage device capable of producing a running sequence of commands to cause the top 14 of the platform 10 to move in accordance with the desired motion sequence for the particular application.

As will be explained below, the microcontroller 80 needs to know two essential things. First, it needs to know what motion is desired. Second, it needs to know what movement of the platform has occurred to verify that the commands will be properly synchronized with the platform position. The first requirement is satisfied by the receipt of input commands from external input unit 120 as recognized by input interface 108 and CPU 102 of the microcontroller 80. The second requirement is provided by the sensors 83 and 85. Sensors 83 each produce a pulse when a fan blade of the motor passes within proximity of the sensor. The number of pulses indicates the amount of rotation of the motor shaft and, thus, the extent of movement of the connecting arm assembly 60. The frequency of the pulses indicates motor speed. Thus, by detecting and counting the pulses from sensors 83, the microcontroller can recognize the speed and extent of movement of each motor and can compute the nature and degree of motion undergone by top 14 relative to base 12.

One preferred embodiment of the essential control sequences performed by microcontroller 80 in accordance with the present invention are shown in FIGS. 6A-6E. As a first step, a power-on initialization procedure is performed in accordance with the flow diagram of FIG. 6A. The initialization procedure ensures that the motion platform 10 is level and that the microcontroller 80 is ready to receive interrupts from other control routines. In step 200 of this procedure, the power source 116 of motion platform 10 is turned ON. With the power ON, commands are sent by the CPU through the output interface 110 to the relays 82 of motors 58. This causes the motors 58 to move, causing the rotating arms 68 to move past their respective arm position sensors 83. The microcontroller detects the signal indicating passage of the arm through this “zero set” position and then begins to count the pulses from the motor fan blade sensor 85. When the predetermined number of pulses has been received to indicate that the arm has been moved to the “home” position corresponding to the level or horizontal orientation of the top 14, all other interrupts are initialized, as represented by step 204, and the motor and CPU are placed in the halt mode 206. In halt mode 206, the power to the system is ON, the top of the platform is steady and level, and the system is ready to receive motion commands.

FIG. 6B illustrates the data interface interrupt sequence, which is the primary control sequence or loop for the system in accordance with the preferred embodiment of the present invention.

A data interface interrupt 208 will occur when the CPU 102 receives data or character input signals from the external control unit 120, such as a computer or other device capable of supplying computer readable characters. Initially, in step 210, the data interface interrupt queries whether the CPU 102 has received a valid command or input signal from the external input unit 120 that corresponds to built in parameters stored in RAM 106. As stated above, these commands include home-straight and level (H), pitch angle positive (P), pitch angle negative (N), acceleration (A), roll angle right (R), roll angle left (L), set speed (SP and SR) for each motor, set vibration (VP and VR) of each motor, status (Q), and ON/OFF (T). If the answer to this query is NO, then the CPU 102 sends an error response in step 212, and the loop halts in step 214. If the CPU 102 has received a valid command, then the command is echoed in step 216. The loop then queries in step 218 whether additional computer readable characters representing parameters of the command are required. For example, if a set speed command SP or SR is received, the system will need to know what particular speed is desired. The system is programmed to recognize a three-digit numerical value from 0 to 999 to indicate a desired speed from zero to the maximum speed of the motors 58. While a three digit numerical value in the range of 0 to 999 has been selected in the present preferred embodiment, it should be appreciated that a lesser or greater range, with fewer or greater numbers could be implemented to accommodate the requirements of a particular application, depending upon the degree of accuracy and control desired.

If the echoed command does not require any additional parameters, then the interrupt answers NO and proceeds to step 220. Here, the CPU 102 conducts a status request, checking to verify that the command corresponds to a status command, namely H, Q, or T, each of which require only a single command without further specifying parameters. If the response to the status request is YES, then, in step 222, the CPU 102 reports the status and proceeds to a halt mode in step 224. If, on the other hand, the response to the status request query is NO, then, in step 226, an error response is sent before proceeding to a halt in step 224.

If, in step 218, a parameters requirement is recognized, then a retrieve sequence is initiated in step 228 to get the complete parameter from the CPU. The CPU 102 then checks to see if the retrieved parameter is valid in step 230. For example, if the system is set to look for a numerical value between 0 and 999, a valid parameter would be any number in that range. If the answer is NO, then an error response is sent in step 226, and the loop is halted in step 224. If the parameter is valid, however, the parameter is set in step 232.

The CPU 102 then checks for an immediate command in step 234. The immediate commands require action or movement of the platform and include commands, for example, P, N, R, and L. If the command is not an immediate command, then the interrupt loop is again halted at step 224. If an immediate command is detected, then the timer interrupt is set in step 236, and, thereafter, the loop is halted in step 224.

Since all of the parameters which call for an immediate command cause the motor/s to move some amount in a forward or reverse direction, the timer interrupt routine, shown in FIG. 6C, is used to set the motor/s speed/direction/ON-OFF status, according to commands in the form of data signals received from the external input unit 120. In the timer interrupt routine, begun at step 238, a speed inquiry is first performed in step 240. If this speed inquiry response is YES, then the motor speed is set in step 242, and a motor flag is generated in step 244 to indicate to the CPU what the motor is doing. The program then continues to perform a vibration inquiry in step 246. If the response to the speed inquiry in step 240 is NO, the program proceeds directly to the vibration inquiry in step 246.

If the response to the vibration inquiry is YES in step 246, then a motor Speed/Direction ON/OFF command is produced in step 248, and a motor flag is generated in step 250 to indicate what the motor is doing. The program then proceeds to a halt in step 252 to await the next interrupt. If the response to the vibration inquiry in step 246 is NO, then the program proceeds directly to the halt mode in step 252, as shown.

The microcontroller 102 also runs an M1/M2 (first motor/second motor) sensor interrupt routine, as shown in FIG. 6D. This routine monitors the second sensors 85 that detect passage of the fan blades of the positioning motors 58. The pulse count and pulse frequency provide extent of motion and speed information to the CPU, as described above.

In step 256, a counter in the CPU 102 is advanced when the sensor detects passage of a fan blade. At each count of the counter, the routine inquires whether a preprogrammed terminal count has been reached at step 258. The preprogrammed terminal count is determined based on how many revolutions of the positioning motor are desired to move the rotating arm into the correct position to achieve the desired pitch angle or roll angle of the top of the motion platform. Once the terminal count has been reached, the routine proceeds to step 260 where the motor is stopped, and the motor status is set. Then the routine proceeds to a halt status in step 262. If the terminal count has not been reached at step 258, then the routine proceeds directly to the halt status in step 262.

To assure that proper synchronization of the system is maintained, the microcontroller 80 also runs a M1H/M2H sensor interrupt routine, as shown in FIG. 6E. This sequence is based on the recognition of the fact that a single shaft rotation of each of the motors 58 is integrally related to rotation of each of the rotating arms 68. Thus, if the motor fan contains twelve blades, as is quite common, twelve pulses of sensor 85 will signal one rotation of the motor shaft. From this, it can be appreciated that for each rotation of the arm 68, and then for each pulse of sensor 83, the number of pulses from the motor fan blade must be an even multiple of twelve. If the fan blade pulse count is not an integral multiple of twelve, the system will recognize that it is out of synchronism and the counters must be reset to re-calibrate the system.

The M1H/M2H sensor interrupt sequence of FIG. 6E accomplishes such re-calibration on initiation of the interrupt at step 264, performing a modulus twelve comparison of the counts of sensors 83 and 85, as described above, and resetting the sensor counts when necessary in step 266 before returning to a sequence halt mode in step 268.

The microcontroller 80 is thus able to control pitch, roll, speed and vibration movements of the motion platform 10 reliably, economically and efficiently. The motion platform is therefore uniquely adaptable to any number of entertainment and commercial simulator applications under any suitable manual or computer control as may be desired depending on the preferences of the end user.

Additional advantages and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims.

What is claimed is:

1. A motion platform for supporting a g-force sensitive load, the motion platform, comprising:
a base;
a top having a g-force sensitive load bearing portion and a support portion;
a support member for supporting the top relative to the base with freedom of movement about at least one horizontal axis;
a pair of positioning motor assemblies mounted to said base;
a respective arm assembly extending between each of said positioning motor assemblies and said top; and
a microcontroller electrically connected to said positioning motor assemblies for controlling a rotational speed and a rotational direction of said positioning motor assemblies and thus angular displacement of said top of said motion platform,
wherein said g-force sensitive load bearing portion of the top is displaced from the support portion of the top at which the support member supports the top.

2. The motion platform according to claim 1, wherein said arm assembly being responsive to rotary motion of a respective one of said positioning motor assemblies and adapted to rotate 360 degrees about said respective positioning motor assembly to effect relative movement of said top about said at least one axis.

3. A motion platform as defined in claim 2, further comprising a first beam extending across said support portion of said top and a second beam extending across said base,
wherein said support member comprises a support beam extending between, and perpendicular to, said first beam and said second beam.

4. A motion platform as defined in claim 3, wherein said second beam bisects said base, and said support beam extends along an axis intersecting a center of said base.

5. A motion platform as defined in claim 4, wherein said base is generally rectangular.

6. A motion platform as defined in claim 5, wherein said top is generally rectangular.

7. A motion platform as defined in claim 1, wherein a length of a side arm of the top is greater than a length of a side arm of the base.

8. A motion platform as defined in claim 2, further comprising a joint positioned between said support beam and said first beam, said joint mounted to said support beam to allow movement of said top relative to said support beam.

9. A motion platform as defined in claim 2, wherein said base is composed of an aluminum alloy.

10. A motion platform as defined in claim 2, wherein said top is composed of an aluminum alloy.

11. A motion platform as defined in claim 2, further comprising solid state relay and delay circuitry electrically connected between said positioning motor assemblies and said microcontroller to allow relatively instantaneous reversal of a direction of rotation of said positioning motor assemblies.

12. A motion platform as defined in claim 11, wherein said base includes motor supports for supporting said positioning motor assemblies, and said solid state relay and delay circuitry is mounted to a bottom surface of at least one of said motor supports.

13. A motion platform as defined in claim 12, wherein said base and said top are generally rectangular and have a front arm, a rear arm, and two side arms,
said motion platform further comprises a first beam connected between the two side arms of the top at the support portion of the top, a second beam bisecting said base, and a fourth beam connected between the two side arms at the g-force sensitive load bearing portion of the top,
said support member comprises a third beam extending between a center of said first beam and a center of said second beam, and
said motor supports extend from said second beam to a top surface of said rear arm of said generally rectangular base, thereby elevating said positioning motor assemblies relative to said base.

14. A motion platform as defined in claim 2, wherein said positioning motor assemblies are elevated above said base.

15. A motion platform as defined in claim 2, wherein each said arm assembly includes a rotating arm for connection to an output of a respective one of said positioning motor assemblies, a connecting arm for connecting a side arm of said top to said rotating arm, and a joint for coupling said rotating arm to said connecting arm to allow angular displacement of said connecting arm relative to said rotating arm.

16. A motion platform as defined in claim 15, wherein, when said top is at a start position, said rotating arm and said connecting arm form an obtuse angle.

17. A motion platform as defined in claim 2, wherein said arm assembly displaces said top of said motion platform where said arm assembly connects to said motion platform up to ±35 degrees from an imaginary plane level with a ground surface.

18. A motion platform as defined in claim 2, wherein said base includes motor supports for supporting said positioning motor assemblies, and said microcontroller is mounted to a bottom surface of at least one of said motor supports.

19. A motion platform as defined in claim 2, wherein said top comprises a one-piece frame.

20. A motion platform as defined in claim 2, wherein said base comprises a one-piece frame.

21. A motion platform as defined in claim 2, further comprising a user module mounted to said g-force sensitive load bearing portion of said top of said motion platform.

22. A method for controlling movement of a motion platform supporting a g-force sensitive load, the method comprising the steps of:
providing a motion platform having a base and a top, the top having a g-force sensitive load bearing portion and a support portion wherein the g-force sensitive load bearing portion is displaced from the support portion;
initializing the motion platform so that a top of the motion platform is level;
receiving data input into a data entry unit, the data being converted into signals for controlling activation, speed, and direction of rotation of positioning motors for positioning the motion platform;
activating the positioning motors in response to the received data;
when the positioning motors are activated, moving the positioning motors in a specific direction and at a specific speed in response to the received data to orient the motion platform.

23. A method as defined in claim 22, wherein said data entry unit receives at least one of real-time data or predetermined data.
